(19) United States
(12) Patent Application Publication
(10) Pub. No.: US 2009/0044089 A1
(43) Pub. Date: Feb. 12, 2009

(54) Automatic insertion of a default function

(75) Inventors: Yaniv Gur, Pittsburgh, PA (US); Peter William Rapp, Pittsburgh, PA (US); Christopher Douglas Weeldreyer, San Carlos, CA (US)

Correspondence Address: VAN PELT, YI & JAMES LLP AND APPLE COMPUTER, INC., 10050 N. FOOTHILL BOULEVARD, SUITE 200, CUPERTINO, CA, 95014, US

(73) Assignee: Apple Inc.

(21) Appl. No.: 11/890,784

(22) Filed: Aug. 6, 2007

(51) Int. Cl. G06F 15/00

(52) U.S. Cl. 715/212

(57) ABSTRACT

Automatically inserting a default function into a host cell is disclosed. In some embodiments, in response to receiving an indication of a selection and/or a specification of a set of one or more cells while in a formula editing mode, a default function is automatically inserted into a host cell into which a formula is being entered with the set of one or more cells as its arguments.

### BACKGROUND OF THE INVENTION

It is common for a user of a spreadsheet application to want to apply a function on the values included in a range of cells. In a typical spreadsheet application, when a user selects a range of cells while in a formula editing mode, the range of the selected cells (e.g., “=A3:A5”) is automatically inserted into the cell into which the formula is being entered. However, typically the user must manually specify a function (e.g., “=SUM(A3:A5)”) in a syntax acceptable by the spreadsheet application, for example by entering text and/or operators conforming to that syntax and/or selecting the function from a toolbar, menu, or other interface, either before or after selecting the range of cells to which the function is desired to be applied. It would be useful if a user did not have to manually specify a function.

Thus, there is a need for an improved manner for providing functions.

### BRIEF DESCRIPTION OF THE DRAWINGS

Various embodiments of the invention are disclosed in the following detailed description and the accompanying drawings.

FIG. 1(a) illustrates an embodiment of entering a formula editing mode in a host cell.

FIG. 1(b) illustrates an embodiment of selecting a cell and the corresponding automatic insertion of a reference to the cell in a host cell.

FIG. 1(c) illustrates an embodiment of selecting a range of cells and the corresponding automatic insertion of a default function with the selected range of cells as its arguments in a host cell.

FIG. 2 illustrates an embodiment of a process for automatically inserting a default function.

### DETAILED DESCRIPTION

The invention can be implemented in numerous ways, including as a process, an apparatus, a system, a composition of matter, a computer readable medium such as a computer readable storage medium or a computer network wherein program instructions are sent over optical or communication links. In this specification, these implementations, or any other form that the invention may take, may be referred to as techniques. A component such as a processor or a memory described as being configured to perform a task includes both a general component that is temporarily configured to perform the task at a given time or a specific component that is manufactured to perform the task. In general, the order of the steps of disclosed processes may be altered within the scope of the invention.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Automatically inserting a default function into a host cell is disclosed. In some embodiments, in response to receiving an indication of a selection and/or a specification of a set of one or more cells while in a formula editing mode, a default function is automatically inserted into a host cell into which a formula is being entered with the set of one or more cells as its arguments.

As used herein, the term “cell” refers to a cell associated with at least standard spreadsheet functionality. The term “at least standard spreadsheet functionality” in the context of a cell includes the ability to define the content of one cell in such a way that the content of the one cell is determined based at least in part on the content of one or more other cells, and the content of the one cell is updated automatically without further human action if the content of one or more of the one or more other cells is changed. As used herein, the term “host cell” refers to a cell in a formula editing mode, i.e., a cell into which a formula is being entered. In some embodiments, cells in a spreadsheet application are organized into one or more individual tables or table objects, each of which includes a desired number of rows and columns of cells. In such cases, a sheet of a spreadsheet document may include a desired number of table objects. Although in many of the examples described herein the cells of a spreadsheet application are organized into such table objects, the techniques described herein may be similarly employed with respect to other cell configurations or organizations, such as the (seemingly) infinite single grid or table of cells in each sheet of some typical spreadsheet applications that includes an unlimited (or very large) number of rows and columns of cells. Although many of the examples provided herein are with respect to a spreadsheet application, the techniques described herein may be similarly employed with respect to any application, spreadsheet or otherwise.

In some embodiments, when one or more cells are selected and/or specified while in a formula editing mode, a default function is automatically inserted into a host cell into which a formula is being entered with the selected and/or specified cells as its arguments. In some embodiments, the default function comprises a “SUM” function, i.e. a function that sums or adds the values included in and/or specified by its arguments. In some embodiments, a user has an option to specify the default function. In various embodiments, a user may specify a pre-defined function (e.g., “SUM”, “PRODUCT”, “SQRT”, etc.) and/or may define a custom function or formula to be the default function. In some embodiments, a user may enable and/or disable an option to automatically insert a default function. In such cases, for example, when enabled, the default function (e.g., SUM( )) is automatically inserted into a host cell when one or more cells (e.g., A3:A5) are selected and/or specified with the selected and/or specified cells as the arguments of the default function (e.g., SUM(A3:A5)), and when disabled, only references of the selected and/or specified cells (e.g., A3:A5) are inserted into the host cell. In some embodiments, the default function is inserted if a non-contiguous or not fully contiguous set of cells is selected and/or specified, using an appropriate syntax for a non-contiguous set of cells as arguments. For example, if non-contiguous cells A3, B6, and G10 are selected while in a formula editing mode with respect to a host cell, in some embodiments, the default function “SUM” is entered automatically and the selected cells included as arguments in a syntax appropriate for a discontinuous set of cells, e.g., “SUM(A3, B6, G10)”. In some embodiments, a default function is automatically inserted into a host cell when two or more cells are selected and/or specified, e.g., if the default function is configured to operate on two or more values.

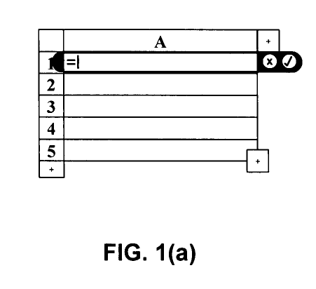

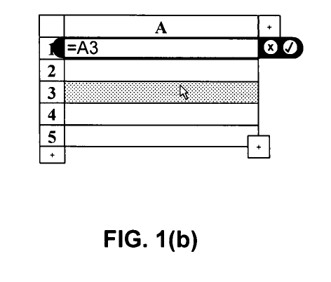

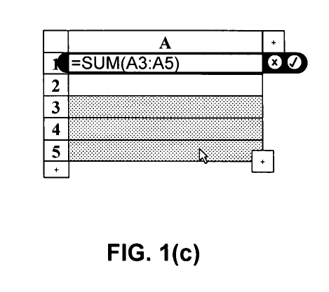

FIGS. 1(a)-(c) illustrate an embodiment of the automatic insertion of a “SUM” function into a host cell. FIG. 1(a) illustrates an embodiment of entering a formula editing mode in a host cell A1 by entering an equals sign “=” into the host cell. FIG. 1(b) illustrates an embodiment of selecting a cell A3 and the corresponding automatic insertion of a reference to cell A3 in host cell A1. In the example of FIG. 1(b), a default function with the selected cell A3 as its argument is not inserted into host cell A1, for example, because the default function (e.g., “SUM”) in the given example operates on two or more values. In other embodiments, if the default function is a function (e.g., “SQRT”) that is configured to operate on a single value, the default function would be inserted in the host cell A1 in FIG. 1(b) with the selected cell A3 as its argument. FIG. 1(c) illustrates an embodiment of selecting a range of cells A3:A5 and the corresponding automatic insertion of a “SUM” function with the selected range A3:A5 of cells as its arguments in host cell A1. The automatic insertion of the “SUM” function as depicted in FIG. 1(c) saves the user from having to manually enter the function in host cell A1 and to supply the correct syntax for the function or to manually select a toolbar button, menu selection, or other control to insert the function. Although the “SUM” function is depicted in FIG. 1(c) as the default function, any other function specified as the default function can be similarly automatically inserted into a host cell in which a formula is being entered when one or more cells are selected and/or otherwise specified.

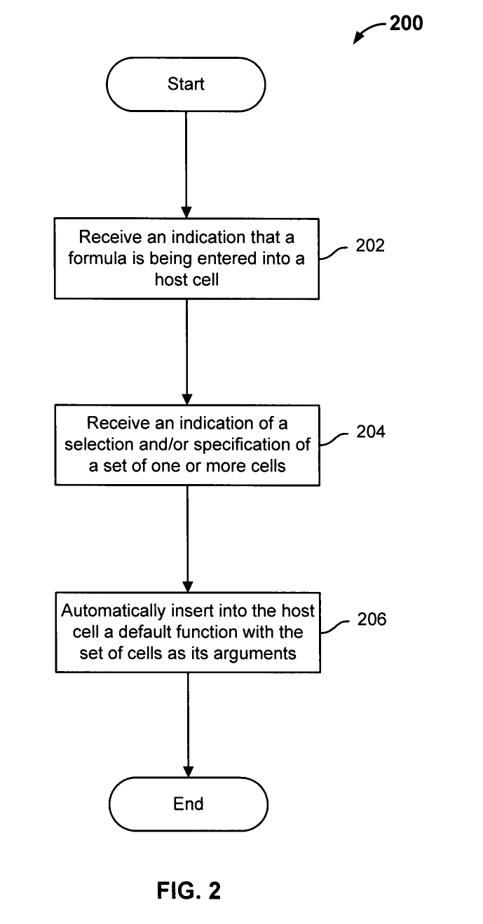

FIG. 2 illustrates an embodiment of a process for automatically inserting a default function. In some embodiments, process 200 is employed with respect to FIG. 1(c) to automatically insert the “SUM” function in host cell A1 with the selected range of cells A3:A5 as its arguments. Process 200 starts at 202 at which an indication that a formula is being entered into a host cell is received. In some embodiments, the indication that a formula is being entered is received at 202 in response to an equals sign “=” being entered into the host cell. At 204, an indication of a selection and/or specification of a set of one or more cells is received. In some embodiments, the set of one or more cells comprises a range of two or more cells. In various embodiments, the indication of 204 is received in response to a drag-selection of a cell range; a clicking on each of one or more cells, e.g., as part of one or more groups or ranges and/or individually; a manual specification of one or more cells via entry into the host cell; and/or any other appropriate selection and/or specification technique. At 206, a default function is automatically inserted into the host cell with the set of one or more cells selected and/or specified at 204 as its arguments, and process 200 subsequently ends. In some embodiments, the default function of 206 comprises a pre-defined function available, for example, in a spreadsheet application. For instance, in some embodiments, the default function comprises a “SUM” function. In some embodiments, the default function of 206 comprises a user-defined function.

As described herein, automatically inserting a default function into a host cell in response to the selection and/or specification of a set of one or more cells may save a user the steps associated with manually entering such a function. If the default function automatically inserted into a host cell is not desired by a user, the user can manually change, delete, or otherwise “undo” the automatic insertion of the function. In some embodiments, a user has an option to disable the automatic insertion of a default function. However, in the cases in which a user frequently uses a particular function, it is useful to automatically insert the function in response to an indication that the function may be desired (e.g., if the user selects and/or specifies one or more cells when in a formula editing mode) so that the user does not have to manually enter the function and be troubled about providing the correct syntax of the function.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method for automatically inserting a default function into a host cell, comprising:
receiving an indication of a selection or a specification of a set of one or more cells; and
automatically inserting into a host cell into which a formula is being entered a default function with the set of one or more cells as its arguments.

2. A method as recited in claim 1, further comprising receiving an indication that a formula is being entered into the host cell.

3. A method as recited in claim 2, wherein receiving an indication that a formula is being entered into the host cell comprises receiving an indication that an equals sign has been entered into the host cell.

4. A method as recited in claim 1, wherein the set of one or more cells includes a range of cells.

5. A method as recited in claim 1, wherein receiving an indication of a selection or a specification of a set of one or more cells comprises receiving a drag-selection of at least a subset of cells included in the set of one or more cells.

6. A method as recited in claim 1, wherein receiving an indication of a selection or a specification of a set of one or more cells comprises receiving a manual specification of one or more cells in the set of one or more cells.

7. A method as recited in claim 1, wherein the default function comprises a pre-defined function.

8. A method as recited in claim 1, wherein the set comprises a plurality of cells and the default function comprises a “SUM” function.

9. A method as recited in claim 1, wherein the default function comprises a user-defined function.

10. A method as recited in claim 1, further comprising providing an option to specify the default function.

11. A method as recited in claim 1, further comprising providing an option to enable or disable automatic insertion of the default function.

12. A method as recited in claim 1, wherein the host cell is in a formula editing mode.

13. A method as recited in claim 1, wherein the host cell and the set of one or more cells are associated with at least standard spreadsheet functionality.

14. A system for automatically inserting a default function into a host cell, comprising:
a processor configured to:
receive an indication of a selection or a specification of a set of one or more cells; and
automatically insert into a host cell into which a formula is being entered a default function with the set of one or more cells as its arguments; and
a memory coupled to the processor and configured to provide instructions to the processor.

15. A system as recited in claim 14, wherein the set comprises a plurality of cells and the default function comprises a “SUM” function.

16. A system as recited in claim 14, wherein the processor is further configured to provide an option to specify the default function.

17. A system as recited in claim 14, wherein the processor is further configured to provide an option to enable or disable automatic insertion of the default function.

18. A computer program product for automatically inserting a default function into a host cell, the computer program product being embodied in a computer readable medium and comprising computer instructions for:
receiving an indication of a selection or a specification of a set of one or more cells; and
automatically inserting into a host cell into which a formula is being entered a default function with the set of one or more cells as its arguments.

19. A computer program product as recited in claim 18, wherein the set comprises a plurality of cells and the default function comprises a “SUM” function.

20. A computer program product as recited in claim 18, further comprising computer instructions for providing an option to specify the default function.

21. A computer program product as recited in claim 18, further comprising computer instructions for providing an option to enable or disable automatic insertion of the default function.
